(19) United States
(12) Patent Application Publication
(10) Pub. No.: US 2010/0257030 A1
(43) Pub. Date: Oct. 7, 2010

(54) Method and system for conducting a contest

(76) Inventor: Howard Crocker, Greenwich, CT (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/384,206

(22) Filed: Apr. 1, 2009

(51) Int. Cl. G06Q 99/00; G06Q 50/00

(52) U.S. Cl. 705/12

(57) ABSTRACT

A contest for selecting a favorite recorded song is conducted by a communication network site, such as an Internet website. The contest may include recorded songs having the same genre. Individuals who desire to enter their recorded songs in a contest or to vote in a contest register with the website. During the course of a contest, individuals with a recorded song in the contest may communicate with voters using the website. Also during the course of a contest, screen displays may be generated on webpages of the website that provide voters with additional opportunities to vote for a favorite recorded song in the contest.

### BACKGROUND OF THE INVENTION

Contests in which contestants perform songs and members of the general public may vote for a favorite contestant have been become popular.

In one contest involving the performance of songs, a panel of judges initially selects a relatively small group of contestants from a very large number of individuals who desire to become professional recording artists. Contestants perform songs on a television show associated with the contest, and members of the public can vote for a favorite contestant, such as by sending a text message or on an Internet website.

The number of individuals that can become contestants in a typical song performance contest, however, is usually very small. In addition, voting for a favorite contestant can occur only within a short time period after the contestants have performed their songs. Further, the contestants have limited opportunities to influence the preferences of potential voters.

Therefore, there exists a need for a song performance contest in which a large number of individuals may easily become contestants. Also, there exists a need for a contest which provides a variety of voting opportunities and permits contestants to communicate with voters.

### SUMMARY OF THE INVENTION

In accordance with aspects of the present invention, a contest is conducted on a communication network site, such as an Internet website, where the contest includes songs recorded by recording users who are registered with the website. The recorded songs in a contest may be of the same genre. Voting users registered with the website may vote for a favorite recorded song included in the contest. During the contest, voting users may view information associated with the recorded songs in the contest on the website. The information associated with a recorded song may include information provided, or created on the website, by the corresponding recording user. In addition, the website provides electronic mail accounts that recording users may use to communicate with voting users during a contest. Further, the website, during the course of a contest, may cause a screen display to be presented to voting users that provides the voting users with an opportunity to vote for selected recorded songs in the contest.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a block diagram of a system in accordance with an aspect of the present invention.

FIG. 2 is a block diagram of an exemplary embodiment of the system of FIG. 1.

FIG. 3 is a flow diagram of a process in accordance with an aspect of the present invention.

FIG. 4 illustrates exemplary profile and communications webpages of a contest website, in accordance with an aspect of the present invention.

FIG. 5 illustrates exemplary contest management webpages of a contest website, in accordance with an aspect of the present invention.

FIG. 6 is an exemplary screen display, in accordance with an aspect of the present invention.

### DETAILED DESCRIPTION

In accordance with aspects of the present invention, a contest for selecting a favorite recorded song is conducted using a communication network site, such as an Internet website. The songs in a contest have been recorded by individuals who are registered as artists with a contest website. Individuals who are registered as voters with the contest website may vote to select a favorite recorded song in a contest. The contest website establishes and manages a contest in which voters select a favorite recorded song from a plurality of recorded songs; provides that artists may communicate with voters during a contest to influence voting; and provides voters with alternative opportunities to vote for a favorite recorded song during a contest.

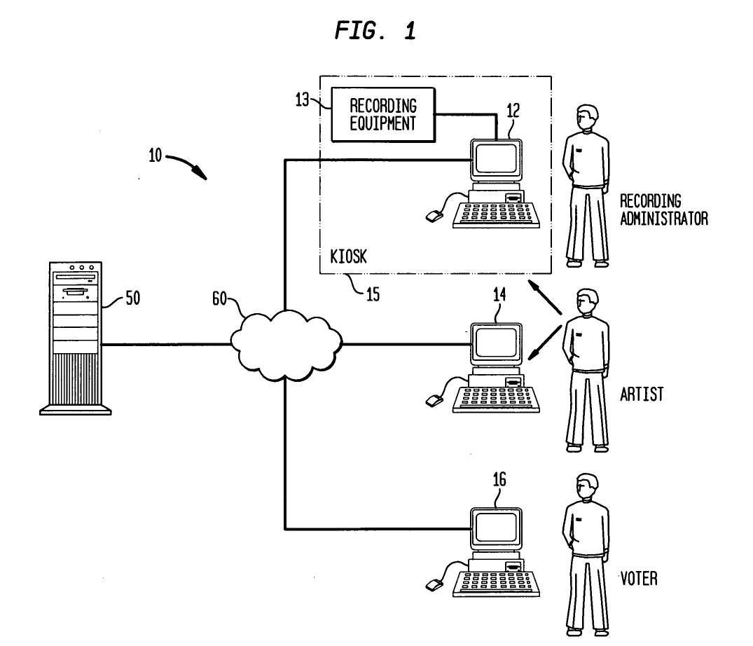

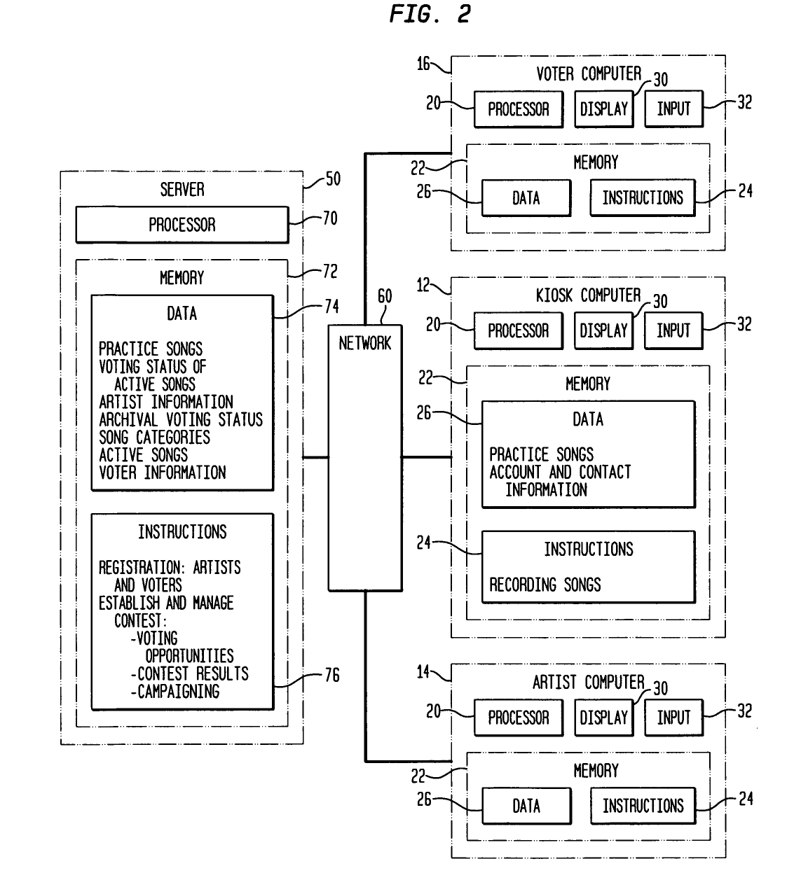

Referring to FIGS. 1 and 2, a system 10 for implementing a contest, in accordance with aspects of the invention, may include client computers 12, 14, 16, which are used to communicate with a server 50 over a communication network 60.

The computer 12 is connected to recording equipment 13. The recording equipment 13 desirably may be professional or studio quality audio recording equipment including microphones, headphones, speakers, audio data playback devices, etc. (not shown). The equipment 13 may be used to produce digital audio data representing an audio recording of the performance of a song. The computer 12 and the recording equipment 13 desirably are included in a kiosk 15 or like housing, such as may be found in a retail shopping mall, a retail store, a restaurant or an entertainment venue, such as a catering hall.

Each of the computers 12, 14, 16 may contain a processor 20, memory 22 and other components typically present in general purpose computers. In addition, the server 50 may contain a processor 70 and a memory 72.

The memory 22 stores information accessible by the processor 20, including instructions 24 that may be executed by the processor 20 and data 26 that may be retrieved, manipulated or stored by the processor 20. Similarly, the memory 72 stores information accessible by the processor 70, including instructions 76 that may be executed by the processor 70 and data 74 that may be retrieved, manipulated or stored by the processor 70. The memory may be of any type capable of storing information accessible by the processor, such as a hard-drive, memory card, ROM, RAM, DVD, CD-ROM, write-capable, read-only memories.

The processors 20, 70 may comprise any number of well known processors, such as processors from Intel Corporation. Alternatively, the processors may be a dedicated controller such as an ASIC.

The instructions 24, 76 may comprise any set of instructions to be executed directly (such as machine code) or indirectly (such as scripts) by the processors 20, 70, respectively. In that regard, the terms “instructions,” “steps” and “programs” may be used interchangeably herein. The instructions may be stored in object code form for direct processing by the processor, or in any other computer language including scripts or collections of independent source code modules that are interpreted on demand or compiled in advance. The functions, methods and routines of instructions in accordance with the present invention are explained in more detail below.

The data 26, 74 may be retrieved, stored or modified by the processors 20, 70 in accordance with the instructions 24, 76, respectively. The data may be stored as a collection of data. For instance, although the invention is not limited by any particular data structure, the data may be stored in computer registers, in a relational database as a table having a plurality of different fields and records, XML documents, or flat files. The data may also be formatted in any computer readable format such as, but not limited to, binary values, ASCII or EBCDIC (Extended Binary-Coded Decimal Interchange Code). Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIG. 2 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one embodiment, each client computer may be a general purpose computer, intended for use by a person, having all the internal components normally found in a personal computer such as a central processing unit (CPU), display 30, input 32 such as a CD-ROM drive, mouse, keyboard or microphone, and a hard-drive, speakers, modem and/or router (telephone, cable or otherwise) and all of the components used for connecting these elements to one another. Moreover, computers in accordance with the systems and methods described herein may comprise any device capable of processing instructions and transmitting data to and from humans and other computers, including network computers lacking local storage capability, PDAs with modems and Internet-capable wireless phones. Although the only input means shown in FIG. 1 are the mouse and keyboard, other means for inputting information from a human into a computer are also acceptable such as a microphone, touch-sensitive screen, voice recognition, etc.

The server 50 and the client computers 12, 14, 16 are capable of direct and indirect communication, such as over the network 60. Although only a few client computers and a single server are depicted in FIGS. 1 and 2, it should be appreciated that a typical system can include a large number of connected computers and several servers to which the computers can connect, with each different computer being at a different node of the network. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. In one embodiment, the server 50 may be a web server, and the client computers include browsers for facilitating communications with the server 50. Although certain advantages are obtained when information is transmitted or received as noted above, other aspects of the invention are not limited to any particular manner of transmission of information. For example, in some aspects, the information may be sent via a medium such as a disk, tape, CD-ROM.

The information may also be transmitted over a global or private network, or directly between two computer systems, such as via a dial-up modem. In other aspects, the information may be transmitted in a non-electronic format and manually entered into the system.

Referring to FIG. 1, the computer 12 and the recording equipment 13 may be operated by a recording administrator to produce, at the computer 12, a digital recorded song file (“recorded song”) from digital audio data supplied by the recording equipment 13. The recording is produced using a digital practice song file (“practice song”), as discussed below.

The computer 14 may be used by an individual, who recorded a recorded song at the kiosk 15, to communicate with the server 50. As discussed below, the individual may use the computer 14 to register as an artist with a contest website provided by the server 50, and provide that the individual's recorded song may be included in a contest conducted by the contest website.

The computer 16 may be used by an individual who desires to vote for a favorite recorded song in a contest conducted on the contest website.

It is to be understood that the system 10 may include a plurality of computers 14 and 16 that individuals may use, respectively, to supply recorded songs to the contest website and vote on recorded songs in contests. It is also to be understood that the system 10 may include a plurality of kiosks 15 at which recorded songs may be produced.

Referring to FIG. 2, the data 74 in the server 50 may include information relating to or including: practice songs from which recorded songs may be produced at the kiosk 15; individuals registered as artists and voters with the contest website; recorded songs in an ongoing contest (“active songs”); voting status of the active songs in ongoing contests; voting status of recorded songs for concluded contests; and categories used for classifying songs by genre.

The instructions 76 may contain instructions that the processor 70 can execute to register individuals as artists and voters with a contest website; and to establish and manage a contest, which includes providing voting opportunities, tracking voting status and providing that artists may campaign for votes by communicating with voters during a contest.

The data 26 in the kiosk computer 12 may include information relating to or including practice songs obtained from the contest website; and contest website account information and contact information for individuals who recorded a recorded song at the kiosk 15.

The instructions 24 of the computer 12 may contain instructions that the processor 20 can execute to produce a recorded song using digital audio data supplied by the recording equipment 13.

In addition to the operations illustrated in FIGS. 1-2, operations in accordance with a variety of aspects of the inventive method will now be described. It should be understood that the following operations do not have to be performed in the precise order described below. Rather, various steps can be handled in reverse order or simultaneously.

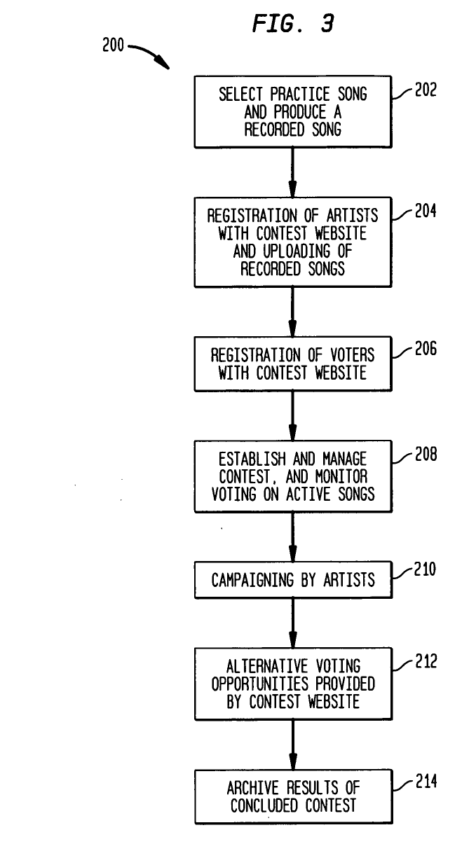

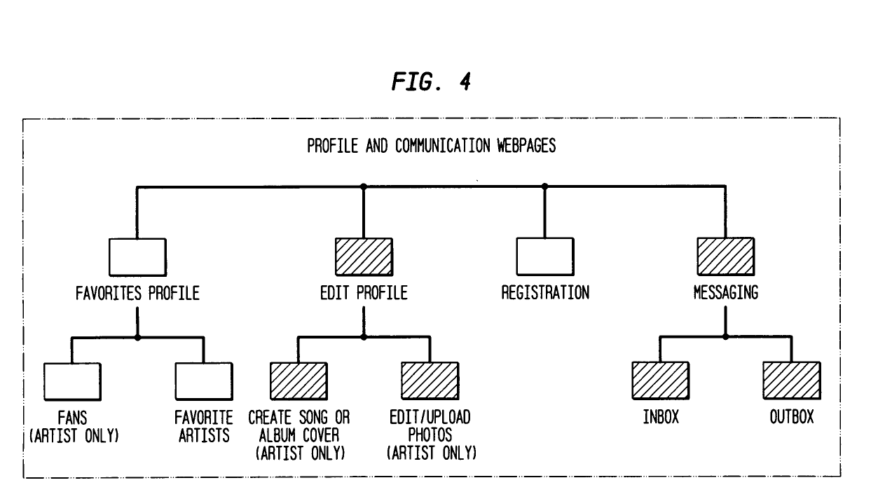

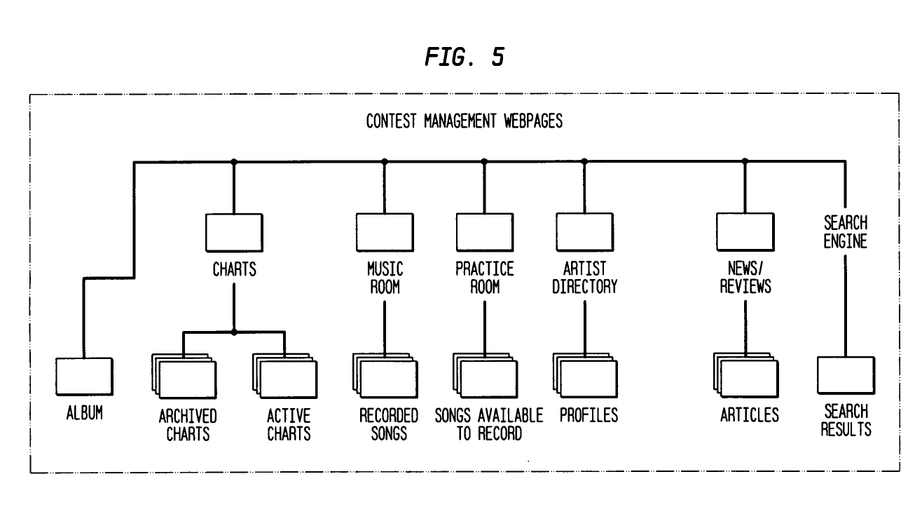

FIG. 3 illustrates an exemplary method 200 for conducting a contest including recorded songs on a contest website, in accordance with aspects of the present invention. For purposes of highlighting features of the present invention, the method 200 is described in connection with operations performed by components of the system 10 of FIGS. 1 and 2, and profile, communications and contest management webpages of a contest website, as shown in FIGS. 4 and 5.

Referring to FIG. 3, in block 202, a recording administrator may use the kiosk computer 12 to retrieve practice songs from the server 50. The practice songs are music-only (karaoke) versions of songs licensed to the server 50, or owned by the owner of the server 50. The practice songs may be classified at the server 50 by genre, such as rock and roll, country, hip-hop, rap, etc.

An individual who desires to participate in a contest conducted by the contest website may visit the kiosk 15. The recording administrator may then have the computer 12 display the practice songs on the display 30 for review by the individual. The kiosk 15 may be located, for example, in a shopping mall or other retail outlet, or in an entertainment venue.

Referring to FIG. 5, the practice songs are included on a practice room webpage of the contest website. In one embodiment, the practice songs may be categorized by genre on the practice room webpage. As discussed below, the contest website provides unlimited access to its webpages only to those individuals who have registered with the contest website to vote in a contest conducted on the contest website (“voters”). Individuals who are not registered as voters with the contest website are provided with only limited access to the webpages of the contest website. The practice room webpage is one of the webpages of the contest website that an individual may access without registering as a voter with the contest website.

In an alternative embodiment, an individual may preview practice songs on the practice room webpage of the contest website by accessing the server 50 using the computer 14, such as from the individual's home.

After the individual selects a practice song, the individual may record a song at the kiosk 15 using the practice song. For example, the individual may sing the lyrics of a selected practice song, for example, a karaoke version of Heartbreak Hotel, while the musical portion of the practice song is played aloud on speakers or headphones of the recording equipment 13. The recording administrator operates the recording equipment 13 to generate digital audio data including the combination of the voice of the individual and the music of the practice song. The digital audio data is supplied to the computer 12 from the recording equipment 13. The computer 12 includes audio recording software that generates the digital audio file corresponding to the recorded song, based on the digital audio data supplied from the equipment 13.

In one embodiment, the kiosk 15 includes a recording room in which an individual may record a song. In addition, the kiosk 15 may include a rehearsal room, which is separate from the recording room and in which an individual may practice singing while a practice song is played aloud. The recording equipment 13 is suitably adapted to include microphones and speakers in each of the rehearsal room and the recording room, such that audio recordings may be made in both rooms.

In addition, in block 202, an individual who records a song at the kiosk 15 supplies contact information, including an email address, to the recording administrator.

After the recorded song has been produced, the recording administrator uses the computer 12 to transmit the contact information for the individual to the server 50 and the recorded song to the individual's email address. The processor 70 of the server 50 uses the contact information to establish an account for the individual with the contest website. The server 50 then transmits account information for the individual to the individual email's address. The account information includes a login code that enables the individual to initially register with the contest website, and thereafter access all of the webpages of the contest website.

In block 204, an individual who recorded a song at the kiosk 15 may use the computer 14 to access a registration webpage of the contest website. An individual who desires to enter a recorded song in a contest conducted on the contest website must initially register as an artist with the contest website. To register as an artist, the individual supplies his login code on a home page of the contest website. In turn, the contest website permits the individual to access the registration webpage. After the individual enters the information requested on the registration webpage, the account for the individual existing on the contest website is activated. The individual is now registered as an artist. Following registration, the individual (artist) may subsequently access all of the webpages of the contest website, simply by initially supplying his login code to the contest website.

Once an individual is registered as an artist with the contest website, the artist may upload a recorded song from the computer 14 to the contest website. The uploading of a recorded song may be performed, for example, when the artist accesses an edit profile webpage of the contest website. In addition, the artist may, by use of the edit profile webpage, supply or create information that becomes associated with a recorded song of the artist. For example, the artist may supply text information, such as biographical information. In addition, the artist may upload content, for example, a picture of the artist or a video created by the artist. The information provided by the artist is stored in the memory 72.

In a further embodiment, the artist may use graphics software available on the edit profile webpage to create a song cover data file (“song cover”) for a recorded song. In one embodiment, the artist may include a photograph and other artistic data, such as clip art, in the song cover.

The processor 70 provides that information associated with a recorded song may be displayed with a title of a recorded song on webpages of the contest website. For example, the song cover and artist for a recorded song may be displayed together with the title of the recorded song on webpages of the contest website.

The processor 70 links a portion of the information associated with a recorded song of an individual to another portion of the information associated with the recorded song. The processor 70 performs such linking automatically, or based on instructions received from the artist when the artist is accessing the edit profile webpage. The linking provides, as conventional in the art, that second information is displayed, for example, on a portion of a first webpage or on another webpage of the contest website, when first information displayed on the first webpage of the contest website and linked to the second information is clicked on, such as by using a mouse and an associated cursor.

For example, referring to FIG. 5, biographical information of an artist may be displayed on an artist directory webpage of the contest website, and also on an artist profile webpage of the contest website. The artist profile webpage desirably is linked to a name of the artist included on the artist directory webpage. Clicking on the name of the artist on the artist directory webpage results in display of an artist profile webpage including the title(s) of recorded song(s) of the artist, and other information associated with the recorded song(s).

In a further embodiment, still referring to FIG. 5, the contest website may include a music room webpage. The music room webpage, when accessed, displays the titles of the recorded songs stored in the server 50, together with their respective artists and genres. The information on the music room webpage may be ordered alphabetically by name of artist, title of the recorded song or genre.

Also in block 204, the artist may establish a personal electronic messaging account on a messaging webpage of the contest website. The messaging account includes an inbox and an outbox. The artist may use the messaging account only by accessing the messaging webpage of the contest website. In addition, an artist can access only his own personal messaging account on the contest website.

In one embodiment, the messaging account may be used only for sending emails to, and receiving emails from, other electronic messaging accounts provided by the contest website. For example, an artist may use his messaging account to transmit emails to, and receive emails from, the messaging accounts of individuals who are registered as voters with the contest website.

Further, during registration of an artist, the processor 70 generates a personalized favorites profile webpage, which includes a favorite artists listing and a fans listing. An artist can access only his own favorites profile webpage on the contest website. The favorite artist listing includes the names of other artists who recorded a recorded song for which an artist voted in a contest. In addition, the favorite artist listing may include another artist that an artist identified as a favorite. The fans listing includes the names of voters who previously voted for a recorded song of an artist.

In block 206, an individual who desires to vote in a contest conducted by the contest website registers as a voter with the contest website. In one embodiment, individuals who become voters are the only persons that can vote for a favorite recorded song in a contest. An individual may register to become a voter without registering to become an artist. In addition, the contest website automatically registers each artist as a voter.

In one embodiment, the contest website suitably provides that, after an individual indicates on the home page of the contest website that the individual desires to register as a voter, the registration webpage is automatically displayed. The individual then provides the requested information on the registration webpage. Upon completion of registration of the voter, the server 50 supplies the voter with a login code. After registration, the voter can subsequently access all of the webpages of the contest website, by submission of the login code to the contest website.

Similarly as discussed above for an artist, the voter may establish a personal electronic messaging account on the messaging webpage. The voter can access his personal messaging account only from the messaging webpage of the contest website. In addition, the voter can access only his own messaging account on the messaging webpage. The voter may use the messaging account to receive emails from and send emails to other messaging accounts on the contest website, such as the messaging accounts of artists and other voters.

In one embodiment, the processor 70 automatically adds the names of voters to a fans listing of an artist, based on the votes cast for the artist during a contest. In another embodiment, the processor 70 automatically adds the names of artists to a favorite artist listing of a voter, based on the votes cast by the voter.

It is to be understood that individuals may continuously record songs and upload recorded songs to the contest website, as discussed above, such that the memory 72 of the server 50 eventually includes many recorded songs of a plurality of different genres. In block 208, the processor 70 of the server 50 establishes and manages a contest when a predetermined number of recorded songs is stored in the memory 72. In one embodiment, the recorded songs in an ongoing contest (“active songs”) may have the same genre, for example, rock and roll. For example, an ongoing contest (“active chart”) may include active songs recorded by different artists using the same practice song, or active songs recorded by different artists using different practice songs having the same genre.

In one embodiment, the contest website may conduct several contests for different genres concurrently. In another embodiment, the server 50 does not commence a contest for a genre if another contest for the same genre is ongoing. Further, a particular recorded song of an artist may not be included in more than a single contest.

In addition, in block 208, the processor 70 continuously monitors voting by voters for the active songs, and maintains an updated record of the current voting status (“ranking position”) of the active songs for each of the corresponding active charts. The ranking positions of active songs on an active chart may be displayed when voters access webpages of the contest website, as described below.

Referring to FIG. 5, a voter who desires to vote on active songs may access a charts webpage of the contest website. The chart webpage displays the active charts, and also includes links to active chart webpages. In one embodiment, the active charts may be displayed on the chart webpage by genre. Each active chart webpage displays the titles of active songs for a specific active chart, the corresponding song covers and also the ranking position for each of the active songs on the active chart. In one embodiment, a voter may vote for an active song on an active chart by clicking on a portion of the title or the song cover for an active song displayed on the active chart webpage. The server 50, in turn, records a vote for the corresponding active song. In a further embodiment, the voter may cause the display of information associated with an active song, such as, on the active chart webpage or another webpage, by clicking on a portion of the title or the song cover that is highlighted on a screen display.

In addition, the charts webpage may display contests that have been concluded (“archived charts”), and links to archived chart webpages. In one embodiment, the archived charts may be displayed on the chart webpage by genre. Each archived chart webpage includes the titles and the final ranking positions of the recorded songs of an archived chart. In a further embodiment, song covers for the corresponding recorded songs are displayed when an archived chart webpage is accessed.

In addition, a voter may vote on active songs by accessing the music room webpage. The voter may cause the music room webpage to display only the titles of active songs, such as alphabetically, by genre or by artist. In addition, a voter may vote for an active song on the music room webpage by clicking on the title. Alternatively, voting icons may be displayed in conjunction with the respective titles on the music room webpage, and a vote may be cast by the voter clicking on a voting icon. In addition, the voter may cause information associated with a recorded song to be displayed on a separate webpage by clicking on the title of the recorded song on the music room webpage.

In another embodiment, the voter may cause the music room webpage to (i) display only active songs; (ii) display with a marking those recorded songs which are active songs; or (iii) display with a marking those recorded songs which are included in archived charts.

In addition, a voter may vote for an active song by accessing the artist directory webpage. The artist directory webpage may display an alphabetical listing of all artists, the titles of recorded songs of the respective artists and the current ranking position of active songs on their respective active charts. A voter can vote for an active song on the artist webpage by clicking on the title of the active song or, alternatively, on a voting icon displayed in conjunction with the title. In addition, information associated with the recorded song and the artist may be displayed, for example, on the same or a different webpage, when the artist name or the title of the active song is clicked on.

In one embodiment, voters may vote for the active songs on an active chart during a portion of a predetermined time period, such as for one month during a two month contest period.

In another embodiment, the number of active songs on an active chart is fixed for the duration of the contest. Voting for the active songs on such chart can occur at any time during the contest.

In still another embodiment, the number of active songs on an active chart may change during the contest. For example, a recorded song may be added to an active chart, so long as the contest is scheduled to continue for at least a predetermined time period, such as at least two more weeks.

In one embodiment, the processor 70 monitors the votes cast by each voter, and automatically updates the voter's personal favorite artists listing.

In another embodiment, when a recorded song of an artist included in the favorite artist listing of a voter is initially uploaded by the artist or becomes an active song, the processor 70 automatically creates an email message in the inbox of the messaging account of the voter. The message may include, for example, a link to information associated with the favorite artist or the email address of the messaging account of the favorite artist.

In a further embodiment, the ranking position of an active song of an artist is automatically displayed when information associated with the active song or the artist of the active song is displayed on a webpage of the contest website.

In block 210, an artist may campaign to increase the number of votes an active song receives during a contest. In one embodiment, the artist may use his electronic messaging account to transmit an email to a voter, such as a voter listed in the artist's fan listing. The email, for example, notifies the voter of the title of an active song of the artist and requests the voter to vote for the active song. In one embodiment, the email may include a link to the artist's biographical information, and also a voting link, which when clicked on by the voter, automatically causes a vote for the active song to be recorded at the server 50.

In a further embodiment, when an artist clicks on the name of a voter listed in the personalized fan listing of the artist, the processor 70 provides for automatic transmission of an email message to the messaging account of the voter. The email message identifies an active song(s) of the artist and includes a voting link. The voter, by clicking on the voting link, causes a vote to be recorded for one or more the active songs of the artist identified in the email message.

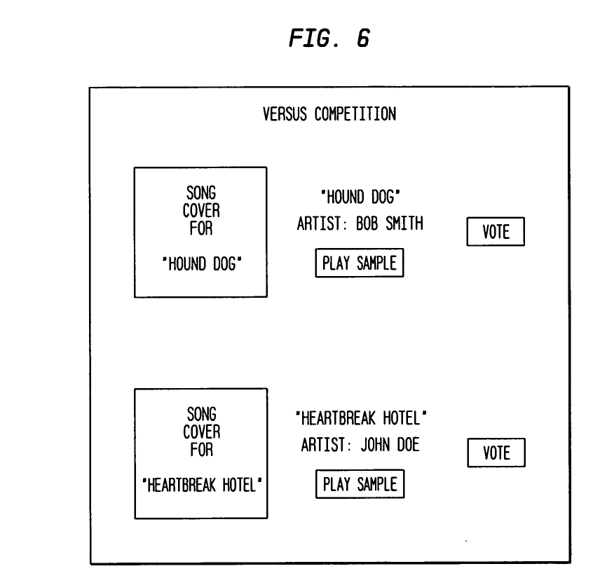

In block 212, the server 50 may generate, on any of the webpages of the contest website, a display that provides an additional opportunity for voting on active songs. In one embodiment, when a voter accesses or refreshes an active chart webpage, a so-called “versus competition” pop-up window, such as shown in FIG. 6, is displayed. The pop-up window displays the titles and song covers, respectively, of two active songs included on the active chart of the active chart webpage. The pop-window includes “play sample” icons for each of the two active songs. When a play sample icon is clicked on, a portion of the corresponding recorded song is automatically played on the computer 16 of the voter. The pop-up window further includes a voting icon for each of the active songs. When the voter clicks on a voting icon, the server 50 automatically records a vote for the corresponding active song. In one embodiment, the voter must cause a portion of each of the two active songs to be played, before the voter can cast a vote by clicking on a voting icon.

Also in block 212, the server 50 may randomly select an artist having an active song as a featured artist. The server 50 then generates a promotional item, such as a press release or news article, concerning the selected artist, from a predetermined template and using the artist's biographical information stored in the memory 72. The promotional item may be displayed on a news and reviews webpage of the contest website, such as in an article included on, or linked to, the news and reviews webpage. Alternatively, the promotional item may be displayed as part of a pop-up display or banner advertisement on one or more of the artist webpage, the music room webpage or the charts webpage, when a voter accesses such webpage(s).

In another embodiment, the processor 70 may select an artist as a featured artist, based on the ranking position or a change in the ranking position of an active song of the artist. For example, if an active song of the artist is currently ranked within three places of the highest ranked active song of an active chart, or has increased its ranking position by a predetermined number of positions, such as by at least five positions, the processor 70 identifies the artist for inclusion as a featured artist in a promotional item.

In a further embodiment, the promotional item may be a banner display including pictures of two artists having active songs on the same active chart. The promotional item is displayed, for example, when a voter accesses the charts webpage or the active chart webpage including the corresponding active chart. The promotional item includes a voting icon for each of the artists. When one of the voting icons is clicked on, the server 50 automatically records a vote for the active song of the corresponding artist.

In still a further embodiment, the promotional item may include the song covers corresponding to two active songs of the same active chart. The promotional item is displayed, for example, when a voter accesses the active chart on the charts webpage or the active chart webpage including the corresponding active chart. The promotional item includes a voting icon for each of the song covers. When the voting icon for a specific song cover is clicked on, the server 50 automatically records a vote for the active song corresponding to that specific song cover.

In another embodiment, a vote resulting from a voter clicking on a voting icon included on a promotional item that displays only pictures of two artists or two song covers for respective active songs is weighted differently, and desirably less, than a vote otherwise cast on the contest website.

In a further embodiment, the artist directory webpage may include favorite artist listings for each genre. The favorite artists for a genre may be determined based on the number of recorded songs of the artist that became active songs in a contest, or the total number of votes that the recorded songs of the artist have received. In one embodiment, the artists for a genre may be ranked to emphasize longevity. For example, the number of contests in which an artist participated over a predetermined period is weighted more heavily than the total number of votes the artist received, so long as, in each contest in which the artist had an active song, the active song of the artist received at least a predetermined number of votes.

In another embodiment, the artist directory webpage may include a top performers directory for each genre. The top performers directory may list the winners of recently concluded contests, such as concluded within the last two months, by genre.

In still another embodiment, the contest website may include an album webpage. The album webpage includes a listing of artists who entered at least a predetermined number of contests on the contest website and where, at the conclusion of each of the contests, the recorded song of the artist had at least a predetermined ranking position. The album webpage further displays the recorded songs of each of the listed artists. In one embodiment, the artist may create an album cover for use on the album webpage by accessing the edit profile webpage and performing actions similar to those described above for creating a song cover.

In block 214, after the conclusion of a contest, the server 50 tabulates the voting results for an active chart, and converts the active chart into an archived chart which is then added to an archived chart webpage. In one embodiment, when a webpage of the contest website, such as the music room webpage, is accessed following the conclusion of a contest, such as within five days of the conclusion of the contest, the voting results for the concluded contest are displayed on a portion of the webpage.

In one embodiment, the contest website may provide for placement of a recorded song onto a retail song distribution website, such as ITUNES. For example, the placement may be based on a request received from an artist. In addition, the contest website may determine whether to place a recorded song on a retail song distribution website based on the ranking position of the recorded song at the conclusion of a contest, or based on how many other recorded songs of the artist were included in contests conducted by the contest website.

In one embodiment, the practice songs that can be used to produce a recorded song for a particular genre change when a contest including active songs of only that genre commences.

In still another embodiment, the contest webpage may include a search engine webpage on which a voter or artist may search the data 74 for information on or relating to artists, voters, recorded songs, ongoing contests and concluded contests.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for conducting a contest:
providing, at a server including a processor, a plurality of recorded songs recorded by a respective plurality of recording users, wherein the recording users are registered with the server;
conducting, by the processor, at least one contest including a plurality of the recorded songs;
displaying information associated with the recorded songs in the contest to voting users, wherein the voting users are registered with the server;
receiving, at the server, votes from the voting users for a favorite recorded song in the contest; and
displaying voting results for the contest.

2. The method of claim 1 further comprising:
transmitting message data from an electronic mail account of a first of the recording users having a first recorded song in the contest to an electronic mail account of a first of the voting users, wherein the electronic mail accounts are accessed using the server.

3. The method of claim 2, wherein the message data includes information associated with the first recorded song.

4. The method of claim 2, wherein the first voting user voted for a recorded song of the first recording user which was included in another contest being conducted or previously conducted by the processor.

5. The method of claim 1 further comprising:
displaying, on a portion of a screen display, information associated with a first recorded song and a second recorded song of the contest; and
receiving a vote, from a first voting user, for the first recorded song or the second recorded song, after a portion of the first recorded song or the second recorded song is audibly played for the first voting user.

6. The method of claim 5, wherein the information displayed with the first and second recorded songs includes at least one of a photograph of, and a data file created, by the corresponding recording user.

7. The method of claim 1, wherein each of the recorded songs includes music from a selected music-only practice song and the voice of the recording user.

8. The method of claim 1 further comprising:
displaying, on a portion of a screen display, first and second selectable voting icons for first and second recorded songs, respectively, of the contest and information associated with each of the first and second recorded songs; and
weighting a vote for the first recorded song or the second recording song received based on selection of the first or the second voting icons, respectively, differently from other votes received at the server.

9. The method of claim 1 further comprising:
displaying, on a portion of a screen display, information associated with a first recorded song of the contest, wherein the first recorded song is randomly selected from the recorded songs in the contest.

10. A system for conducting a contest comprising:
a recording assembly for recording songs by a plurality of recording users;
a memory including instructions for conducting a contest including recorded songs;
a server including the memory and a processor for performing the instructions in the memory, wherein the instructions include:
conducting the contest including a plurality of the recorded songs recorded using the recording assembly, wherein the recording users who recorded the recorded songs in the contest are registered with the server;
displaying information associated with the recorded songs in the contest to voting users, wherein the voting users are registered with the server;
receiving votes from the voting users for a favorite recorded song in the contest; and
displaying voting results for the contest.

11. The system of claim 10, wherein the server includes a first electronic mail account of a first recording user having a first recorded song in the contest and a second electronic mail account of a first of the voting users, wherein the mail accounts are accessed using the server.

12. The system of claim 11, wherein message data transmitted from the electronic mail account of the first recording user to the electronic mail account of the first voting users includes information associated with the first recorded song.

13. The system of claim 12, wherein the first voting user voted for a recorded song of the first recording user in another contest being conducted or previously conducted at the server.

14. The system of claim 11, wherein the instructions performed by the processor include:
displaying, on a portion of a screen display, information associated with a first recorded song and a second recorded song of the contest; and
recording a vote received, from a first voting user, for the first recorded song or the second recorded song, after a portion of the first recorded song or the second recorded song is audibly played for the first voting user.

15. The system of claim 14, wherein the information displayed with the first and second recorded songs includes at least one of a photograph of, and a data file created by, the corresponding recording user.

16. The system of claim 10, wherein each of the recorded songs includes music from a selected music-only practice song and the voice of the recording user.

17. The system of claim 10, wherein the instructions performed by the processor include:
displaying, on a portion of a screen display, first and second selectable voting icons for first and second recorded songs, respectively, of the contest and information associated with each of the first and second recorded songs; and
weighting a vote for the first recorded song or the second recorded song received based on selection of the first or the second voting icons, respectively, differently from other votes received at the server.

18. The system of claim 10, wherein the instructions performed by the processor include:
displaying, on a portion of a screen display, information associated with a first recorded song of the contest, wherein the first recorded song is randomly selected from the recorded songs in the contest.

19. The system of claim 10, wherein the memory includes a fans directory of a first recording user and wherein the processor automatically stores names of the voting users who voted for a recorded song of the first recording user in the fans directory of the first recording user.

20. The system of claim 11, wherein the memory includes a favorites directory of a first voting user and wherein the processor automatically stores names of the recording users whose recorded songs received a vote from the first voting user in the favorites directory of the first voting user.
